(19) United States
(12) Patent Application Publication
(10) Pub. No.: US 2021/0397485 A1
(43) Pub. Date: Dec. 23, 2021

(54) DISTRIBUTED STORAGE SYSTEM AND REBALANCING PROCESSING METHOD

(71) Applicant: Hitachi, Ltd., Tokyo (JP)

(72) Inventors: Yuki SAKASHITA, Tokyo (JP); Takaki NAKAMURA, Tokyo (JP); Hitoshi KAMEI, Tokyo (JP)

(73) Assignee: Hitachi, Ltd.

(21) Appl. No.: 17/200,417

(22) Filed: Mar. 12, 2021

(30) Foreign Application Priority Data
Jun. 17, 2020 (JP) 2020-104544

(51) Int. Cl. G06F 9/50; H04L 29/08

(52) U.S. Cl. CPC G06F 9/5083; G06F 9/5016; H04L 67/1097

(57) ABSTRACT

In a distributed storage system, a volume classifier classifies a plurality of volumes into a plurality of groups on the basis of a fluctuation cycle of a load in each volume, a processor (a resource classifier) calculates a total load obtained by summing the loads of the plurality of volumes on the same node within a group at each time and calculates a group load on the basis of a peak of the total load, and the processor of one node (a rebalancer) calculates the group load on a movement destination node in a case where a volume as a movement candidate in rebalancing that moves the volume between nodes is moved from a movement source node to the movement destination node, determines a volume to be moved in the rebalancing and a movement destination volume on the basis of the calculated group load on the movement destination node, and performs the rebalancing.

### BACKGROUND OF THE INVENTION

### 1. Field of the Invention

The present invention relates to a distributed storage system including a plurality of nodes each having a processor and a memory and connected to each other by a network, and a rebalancing processing method in the distributed storage system.

### 2. Description of the Related Art

Recently, for cost reduction in an organization in which there are a large number of users and a large amount of data is handled, there has been a tendency for a company or the organization to construct a private cloud for itself rather than a public cloud provided by a cloud operator, and provide each section within the organization with an infrastructure, a platform, or the like as service. In addition, in order to reduce the total cost of ownership (TCO) of a storage for constructing the private cloud, there have been an increasing number of cases where a distributed storage in which storage functions are implemented as software on inexpensive general-purpose servers or a storage referred to as a software defined storage (SDS) is used instead of a conventional machine for exclusive use as a storage. In the private cloud, various applications operate, and there are service level agreements (SLAs) with different latencies for different pieces of data. Thus, an automation technology for reducing operation cost and improving a resource usage efficiency has been drawing attention.

In an environment in which there are a large number of computers for storage, and various workloads are mixed with each other as in the above-described private cloud, requirements of each piece of data need to be satisfied by automatically moving data (volume) without an administrator manually determining a movement destination of the data, and there is a problem of how to place volumes on each node automatically.

As a conventional technology related to the above-described problem, a technology related to a storage distributed resource scheduler (DRS) is disclosed in U.S. Pat. No. 8,935,500, for example. In the storage DRS disclosed in U.S. Pat. No. 8,935,500, data is rearranged on each computer for storage such that loads are leveled between nodes on the basis of statistical information. In addition, JP-2014-178975-A discloses a computer device intended to remedy a decrease in access performance which decrease is caused by a load on a virtual storage or the like. The computer device disclosed in JP-2014-178975-A controls an increase or a decrease in memory capacity of a cache memory according to a usage frequency of the cache memory.

In an environment in which there are a large number of computers for storage and various workloads are mixed with each other as in the above-described private cloud, an optimization algorithm that searches for an optimum volume placement on each node is used in order to appropriately place volumes on each node so as to satisfy data requirements. In this typical optimization algorithm, an optimum volume placement can be searched for by solving a combinatorial optimization problem between volumes. However, letting n be the number of volumes, an amount of calculation of the combinatorial optimization problem is known to increase by O(n²). Therefore, in a large-scale environment with a large number n of volumes, the amount of calculation of the combinatorial optimization problem between the volumes is very large, so that it is difficult to take timely action because a period of calculation is lengthened. In addition, a large amount of resources for calculation are needed to solve the optimization problem involving the very large amount of calculation.

The present invention has been made in view of the above points. The present invention is intended to propose a distributed storage system and a rebalancing processing method that can reduce the calculation amount of combinatorial optimization calculation between volumes.

### SUMMARY OF THE INVENTION

In order to solve such problems, in the present invention, there is provided a distributed storage system including: a plurality of nodes connected to each other by a network, having a processor and a memory, and configured to provide a plurality of volumes from and to which a higher level system inputs and outputs data; and a storage medium configured to store the data input and output to the volumes; the plurality of volumes being classified into a plurality of groups on a basis of a fluctuation cycle of a load in each volume, the processor calculating a total load obtained by summing the loads of the plurality of volumes on a same node within a group at each time, and calculating a group load on a basis of a peak of the total load, and the processor of one node calculating the group load on a movement destination node in a case where a volume as a movement candidate in rebalancing that moves the volume between nodes is moved from a movement source node to the movement destination node, determining a volume to be moved in the rebalancing and a movement destination volume on a basis of the calculated group load on the movement destination node, and performing the rebalancing.

In addition, in order to solve such problems, in the present invention, there is provided a rebalancing processing method performed by a distributed storage system including a plurality of nodes connected to each other by a network, having a processor and a memory, and configured to provide a plurality of volumes from and to which a higher level system inputs and outputs data, and a storage medium configured to store the data input and output to the volumes, the rebalancing processing method including: classifying the plurality of volumes into a plurality of groups on a basis of a fluctuation cycle of a load in each volume; by the processor, calculating a total load obtained by summing the loads of the plurality of volumes on a same node within a group at each time, and calculating a group load on a basis of a peak of the total load; and by the processor of one node, calculating the group load on a movement destination node in a case where a volume as a movement candidate in rebalancing that moves the volume between nodes is moved from a movement source node to the movement destination node, determining a volume to be moved in the rebalancing and a movement destination volume on a basis of the calculated group load on the movement destination node, and performing the rebalancing.

According to the present invention, it is possible to reduce the calculation amount of combinatorial optimization calculation between volumes.

### BRIEF DESCRIPTION OF THE DRAWINGS

FIG. 1 is a block diagram showing an example of a configuration of a distributed storage system 1 according to one embodiment of the present invention;

FIG. 2 is a block diagram showing an example of a configuration of a software stack of each node constituting the distributed storage system 1;

FIG. 3 is a schematic diagram showing a relation of software modules to the distributed storage system 1;

FIG. 4 is a diagram of assistance in explaining a concept of grouping of volumes in the present embodiment;

FIG. 5 is a diagram of assistance in explaining a concept of grouping of resources in the present embodiment;

FIG. 6 is a block diagram showing an example of a configuration of a memory map;

FIG. 7 is a diagram showing an example of a configuration of a node configuration table 121;

FIG. 8 is a diagram showing an example of a configuration of a volume load table 122;

FIG. 9 is a diagram showing an example of a configuration of a node load table 123;

FIG. 10 is a diagram showing an example of a configuration of a group cycle table 124;

FIG. 11 is a diagram showing an example of a configuration of a volume group table 125;

FIG. 12 is a diagram showing an example of a configuration of a volume placement table 126;

FIG. 13 is a diagram showing an example of a configuration of a monitor frequency table 127;

FIG. 14 is a diagram showing an example of a configuration of a resource capacity table 128;

FIG. 15 is a flowchart showing an example of a processing procedure of processing by a monitor 200;

FIG. 16 is a flowchart showing an example of a processing procedure of processing by a volume classifier 300;

FIG. 17 is a diagram of assistance in explaining the decomposition of a waveform of load fluctuation;

FIG. 18 is a flowchart showing an example of a processing procedure of processing by a resource classifier 400;

FIG. 19 is a flowchart showing an example of a processing procedure of processing by a rebalancer 500;

FIG. 20 is a flowchart showing an example of a processing procedure of group adjustment processing; and

FIG. 21 is a flowchart showing an example of a processing procedure of volume rearrangement processing.

### DESCRIPTION OF THE PREFERRED EMBODIMENTS

One embodiment of the present invention will hereinafter be described with reference to the drawings. It is to be noted that the embodiment to be described in the following does not limit the invention related to claims, and that not all of combinations of features described in the embodiment are necessarily essential to the solving means of the invention. In the following description, while various kinds of information may be described by expressions such as a “table,” a “list,” a “queue,” and the like, the various kinds of information may be expressed by data structures other than a “table,” a “list,” a “queue,” and the like. An “XX table,” an “XX list,” and the like may be referred to as “XX information” in order to indicate that there is no dependence on a data structure. An expression such as “identification information,” an “identifier,” a “name,” an “ID,” a “number,” or the like will be used when the content of each piece of information is described. However, these expressions are mutually interchangeable.

The present embodiment discloses a distributed storage system. A basic description of the distributed storage system will be made first.

The distributed storage system is constructed by connecting a plurality of storage computers each including a storage device, a processor, and the like to each other via a network. Each computer is referred to also as a node in the network. Each computer constituting the distributed storage system is referred to also as a storage node in particular. Each computer constituting a compute cluster is referred to also as a compute node.

An operating system (OS) for managing and controlling the storage node is installed on the storage node constituting the distributed storage system. Storage software having functions of the storage system is operated on the OS. The distributed storage system is thereby constructed. The distributed storage system can be constructed also by operating the storage software in the form of a container on the OS. A container is a mechanism for packaging one or more pieces of software and configuration information. In addition, the distributed storage system can also be constructed by installing a virtual machine monitor (VMM) on the storage node, and operating the OS and software as a virtual machine (VM).

In addition, the present invention is applicable also to a case where a system referred to as a hyper-converged infrastructure (HCI) is constituted. The HCI is a system that enables a plurality of pieces of processing to be performed on one node by operating an application, middleware, management software, and a container in addition to the storage software on an OS or a hypervisor installed on each node.

The distributed storage system provides a host with a storage pool obtained by virtualizing the capacity of storage devices on a plurality of storage nodes and logical volumes (also referred to simply as volumes). When the host issues an IO to one of the storage nodes, the distributed storage system transfers the IO command to a storage node that retains data specified by the IO command, and thereby provides the host with access to the data. Because of this feature, the distributed storage system can move volumes between storage nodes without stopping the IO command from the host.

An administrator of the distributed storage system can perform processing such as creation, deletion, or movement of a volume by issuing a management command to the distributed storage via the network. In addition, the distributed storage system can notify the administrator or a management tool of the state of the distributed storage system such as usage conditions of drives and usage conditions of processors in the distributed storage system by providing information transmitted by the distributed storage system via the network.

A distributed storage system 1 according to the present embodiment will be described in detail.

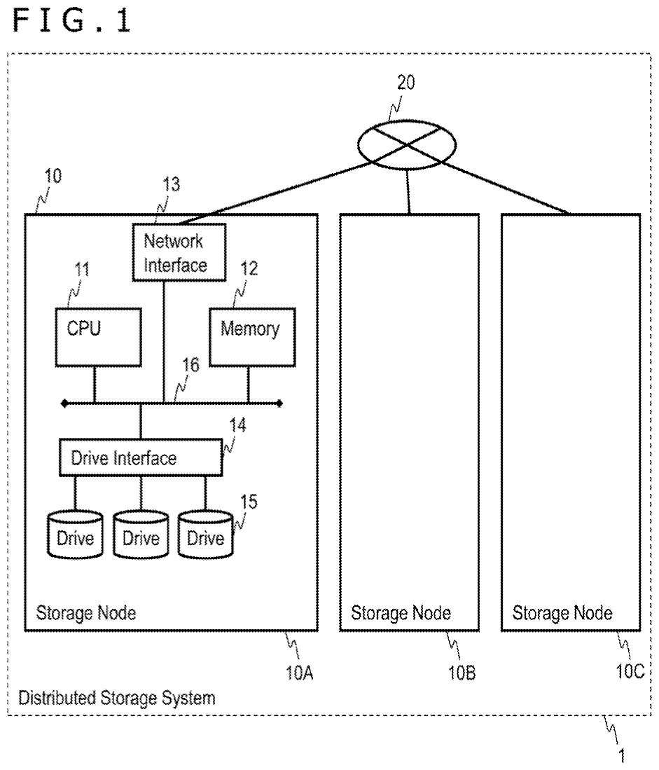

FIG. 1 is a block diagram showing an example of a configuration of a distributed storage system 1 according to one embodiment of the present invention. As shown in FIG. 1, the distributed storage system 1 is constructed by connecting a plurality of storage nodes 10 to each other via a network 20. The hardware configuration of each storage node 10 is not particularly limited. However, as in a storage node 10A shown in FIG. 1, for example, each storage node 10 includes a central processing unit (CPU) 11, a memory 12, a network interface 13, a drive interface 14, a drive 15, an internal network 16, and the like. The storage node 10A, for example, is connected to the network 20 via the network interface 13 and communicates with other storage nodes 10B and 10C.

Incidentally, though not illustrated in FIG. 1, the network 20 that connects the plurality of storage nodes 10 constituting the distributed storage system 1 to each other may be formed by connecting a plurality of networks 20 in a same layer or in different layers. Then, a geographical distance between these plurality of networks 20 is not limited. In addition, while FIG. 1 shows the storage nodes 10A to 10C as an example of the storage nodes 10 constituting the distributed storage system 1, the distributed storage system 1 according to the present embodiment may be of a configuration including an optional number of storage nodes 10. Hence, supposing for example that the network 20 to which the storage nodes 10A to 10C are connected is connected to another network 20 constructed at a geographically sufficiently remote location, and that a storage node 10D and a storage node 10E are connected to the other network 20, the data of the storage nodes 10A to 10C can be stored also in the storage nodes 10D and 10E as a measure against a disaster.

In addition, while all of the nodes constituting the distributed storage system 1 are storage nodes in FIG. 1, the nodes that can constitute the distributed storage system 1 in the present embodiment are not limited to storage nodes, but may be HCI nodes, compute nodes, or the like.

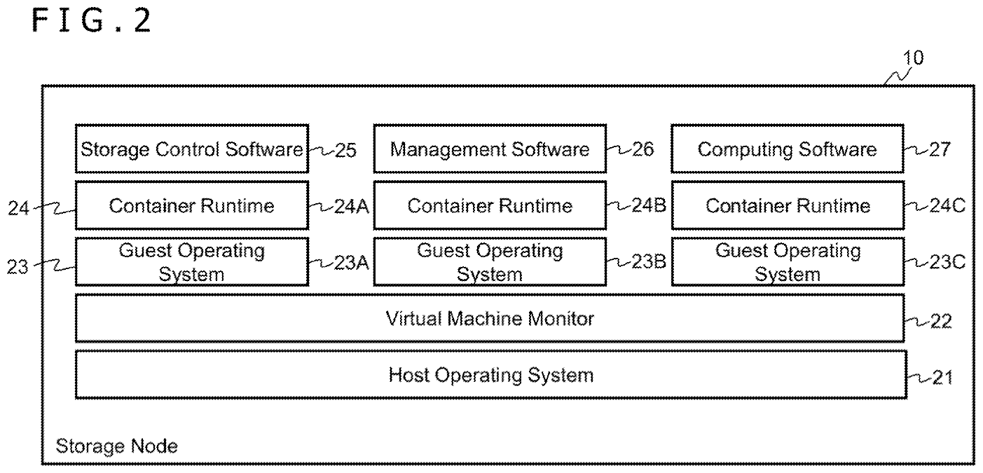

FIG. 2 is a block diagram showing an example of a configuration of a software stack of each node constituting the distributed storage system 1. As shown in FIG. 2, in one storage node 10, a host OS 21 for controlling hardware operates, and a VMM 22 for operating one or more guest OSs 23 (23A to 23C individually) as a VM operates on the host operating system.

A container runtime 24 (24A to 24C individually) for operating one or more containers operates on each guest OS 23. Storage software 25, management software 26, and computing software 27 operate on the container runtimes 24.

Incidentally, the storage software 25, the management software 26, and the computing software 27 do not necessarily need to operate on all of the storage nodes 10. In addition, the management software 26 and the computing software 27 may, for example, be operated on a physical node outside the distributed storage system 1.

In addition, the above-described software stack can adopt a configuration in which the host OS 21 is omitted, and the VMM 22 is directly installed on the physical node.

In addition, the storage software 25, the management software 26, and the computing software 27 can also be operated on the guest OSs 23 without the intervention of the container runtimes 24.

In addition, each piece of software described above can also be operated without taking the form of a VM. In that case, the VMM 22 and the guest OS 23 can be omitted in the software stack. Further, the container runtimes 24 can also be omitted from that state. In that case, each piece of software described above operates on the host OS 21.

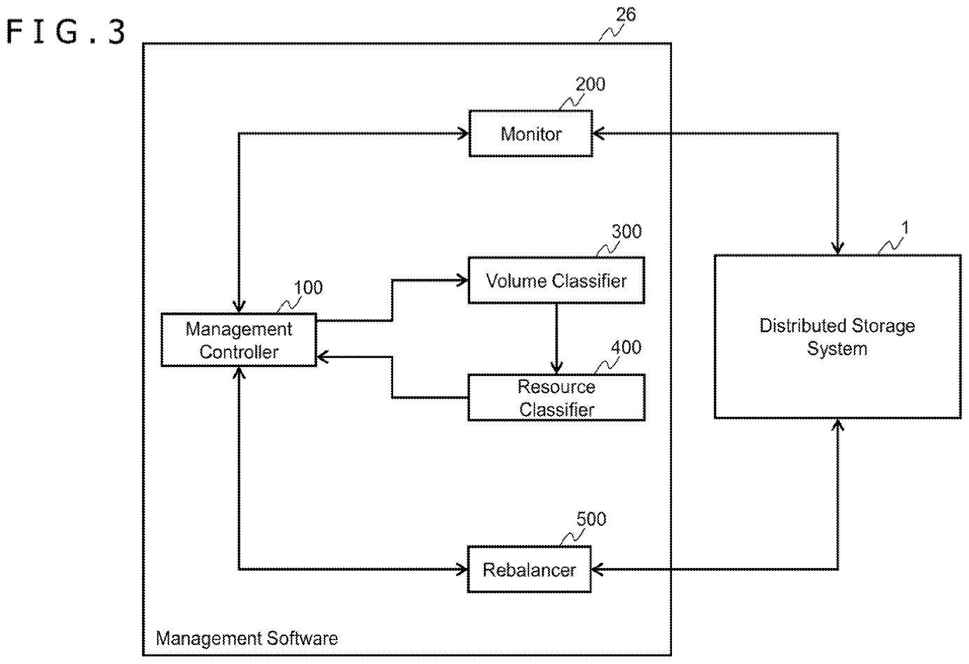

FIG. 3 is a schematic diagram showing a relation of software modules to the distributed storage system 1. As shown in FIG. 3, the management software 26 includes, as software modules, a management controller 100, a monitor 200, a volume classifier 300, a resource classifier 400, and a rebalancer 500. The software modules described above can communicate with each other according to solid lines with arrows shown in FIG. 3, and can access various kinds of tables to be described later and refer to and update data therein. Incidentally, not all of the software modules shown in FIG. 3 need to be implemented on the same node. A mode in which each software module is executed may be an optional method such as a process or a container. In addition, while the distributed storage system 1 is shown so as to be present outside the software modules of the management software 26 in FIG. 3, this represents a conceptual relation, and in actuality, as shown in FIG. 1 and FIG. 2, the management software 26 may be considered to be one of software stacks within the nodes (storage nodes 10) constituting the distributed storage system 1. However, a location at which each software module is executed may be on another node as long as the location at which each software module is executed is a location at which access to the distributed storage system 1 can be made via the network 20.

The management controller 100 is software that calls other software according to a determined schedule.

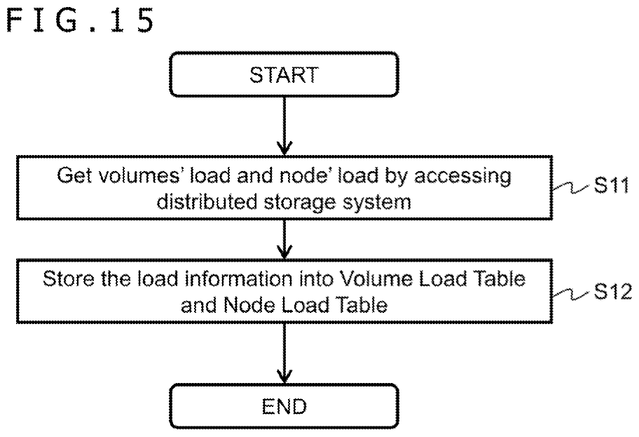

The monitor 200 is a module that accesses the distributed storage system 1 and obtains performance information (in other words, load information) in time series. The load information is information indicating a load of each resource (a CPU, a memory, a drive, or the like) which load is caused by an IO issued to each volume, migration, or the like. The load information may be retained as load information of each resource by the distributed storage system 1, or may be converted into load information of each resource on the basis of IO information. The monitor 200 is called by the management controller 100 according to a frequency for each group which frequency is shown in a monitor frequency table 127 to be described later in FIG. 13, and obtains the load information and stores the load information at a predetermined storage destination. A concrete processing procedure of processing by the monitor 200 will be described later with reference to FIG. 15.

The volume classifier 300 is a software module for classifying volumes provided to the distributed storage system 1 into a plurality of groups. In the distributed storage system 1, a large number of volumes are stored on a large number of storage nodes 10, and the storage nodes 10 have different performance characteristics. Thus, there is a problem of how to place the volumes on the storage nodes 10. Some optimizing algorithms search for an optimum volume placement by solving a combinatorial optimization problem between volumes, so that letting n be the number of volumes, an amount of calculation increases by O(n²). Accordingly, the present embodiment makes it possible to reduce an amount of calculation in the combinatorial optimization problem between volumes by classifying a set of volumes into a plurality of groups (grouping), and thereby reducing the number n of volumes per group.

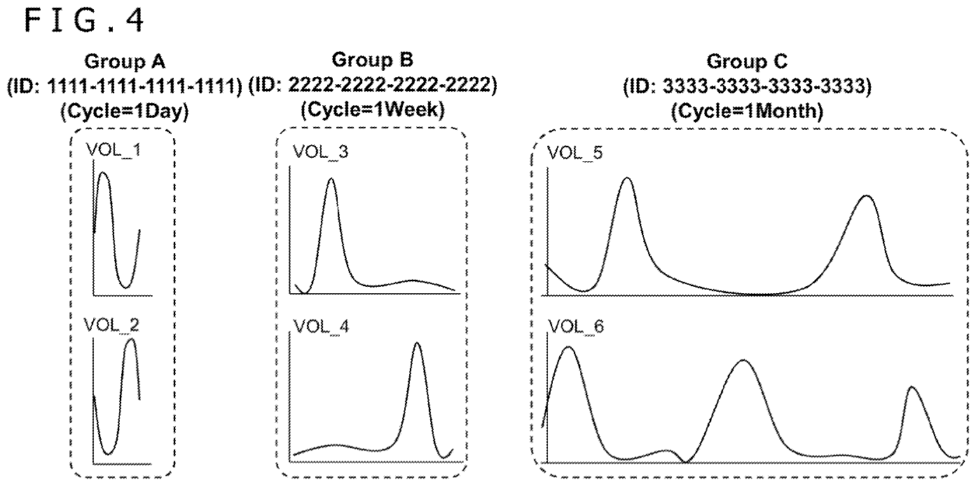

FIG. 4 is a diagram of assistance in explaining a concept of grouping of volumes in the present embodiment. Supposing that a load on each volume fluctuates according to a time series, when volumes having a same cycle of load fluctuation are set in a same group and placed on a same node, mutual load interference between the volumes within the group is fixed, and therefore it becomes easy to calculate a peak value of total load of load of the respective volumes. Further, when volumes having load peaks at different times are set in a same group and placed on a same node, the peaks of the load of the volumes within the group do not occur at the same time, and many volumes can be placed on each storage node 10 efficiently.

Specifically, for six volumes “VOL_1” to “VOL_6,” FIG. 4 shows fluctuations in time series of loads (workloads) on the respective volumes. In such FIG. 4, the volume “VOL_1” and the volume “VOL_2” have a load fluctuation cycle (in other words, a longest cycle in which a workload fluctuates) of one day, and have load peaks in different timings. Thus, the volume “VOL_1” and the volume “VOL_2” are grouped into a same group A. Similarly, the volumes “VOL_3” and “VOL_4” have a load fluctuation cycle of one week, and have load peaks in different timings. Thus, the volumes “VOL_3” and “VOL_4” are grouped into a same group B. In addition, similarly, the volumes “VOL_5” and “VOL_6” have a load fluctuation cycle of one month, and have load peaks in different timings. Thus, the volumes “VOL_5” and “VOL_6” are grouped into a same group C.

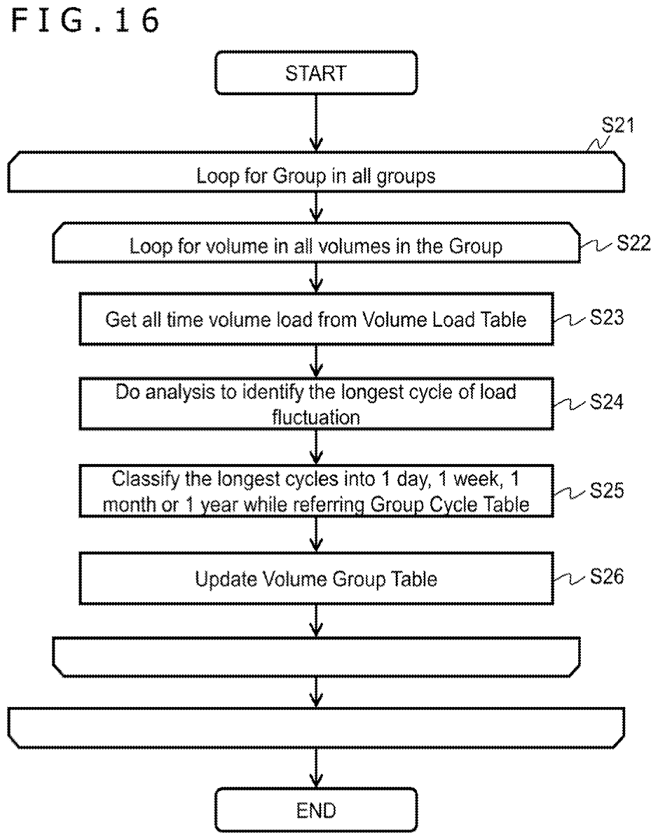

As described above, the volume classifier 300 groups volumes by respective longest cycles of load fluctuation (longest cycle in which a workload fluctuates) so that load of volumes within a group do not interfere with each other and many volumes can be placed on each storage node 10 efficiently. Incidentally, the longest cycle of load fluctuation in each volume can be determined by identifying a component having a longest cycle among a few components having predominant cycles from the load fluctuation in each volume. A concrete processing procedure of processing by the volume classifier 300 will be described later with reference to FIG. 16.

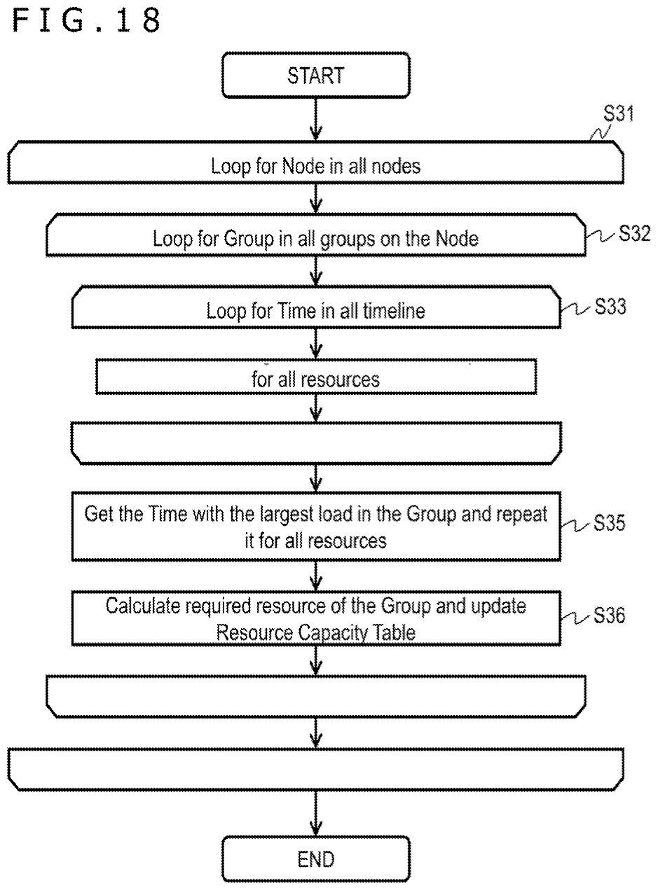

The resource classifier 400 is a software module that classifies resources on each storage node 10 in the distributed storage system 1. The resource classifier 400 classifies resources assigned to each volume into the above-described plurality of groups, according to the classification of volumes by the volume classifier 300 into a plurality of groups. The resource classifier 400 can thereby dynamically determine an amount of resources assigned to each volume. A concrete processing procedure of processing by the resource classifier 400 will be described later with reference to FIG. 18.

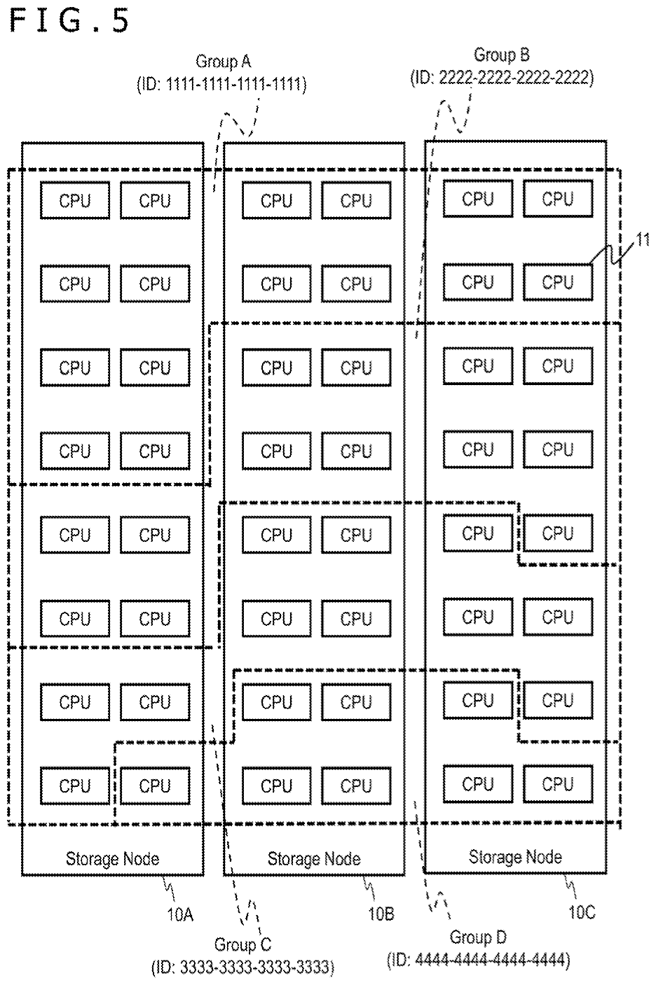

FIG. 5 is a diagram of assistance in explaining a concept of grouping of resources in the present embodiment. In FIG. 5, CPUs 11 possessed by the storage nodes 10A to 10C constituting the distributed storage system 1 are set as an example of resources, and an image of grouping of the resources is shown. FIG. 5 indicates that the plurality of CPUs 11 of the respective storage nodes 10A to 10C are grouped into four groups (groups A to D) straddling the nodes. Incidentally, while FIG. 5 shows the CPUs 11, other resources possessed by the storage nodes 10 can also be grouped under the same concept.

In addition, while in FIG. 5, the resources are virtually grouped so as to straddle one or a plurality of nodes, the grouping of resources in the present embodiment is not limited to this, but the resources may be grouped in each of the one or plurality of nodes. However, virtually grouping the resources so as to straddle the one or plurality of nodes has an advantage in that even in a case where a workload cycle changes and a change occurs in the grouping of volumes, the data of the volumes do not need to be migrated between nodes.

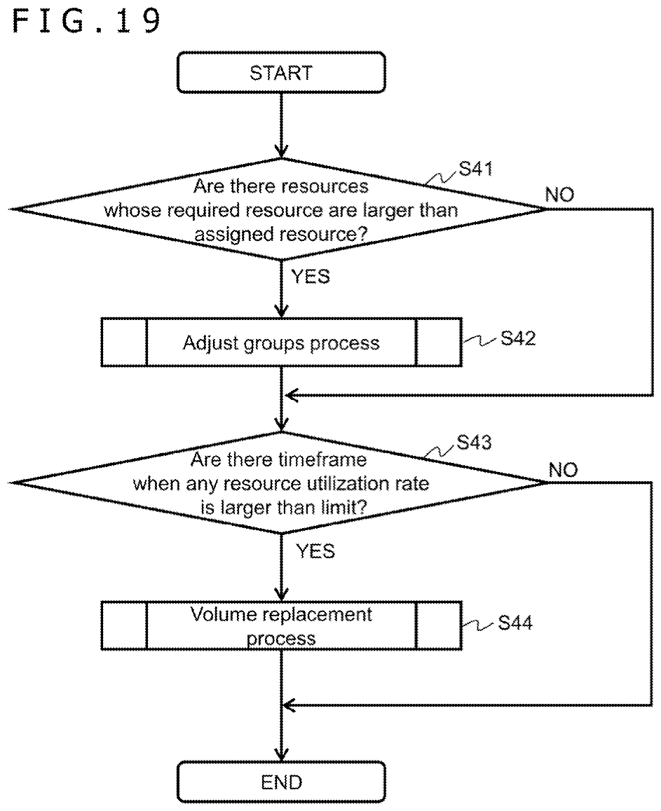

The rebalancer 500 is a software module that adjusts the assignment of the resources to the volumes classified into the plurality of groups. A concrete processing procedure of processing by the rebalancer 500 will be described later with reference to FIGS. 19 to 21.

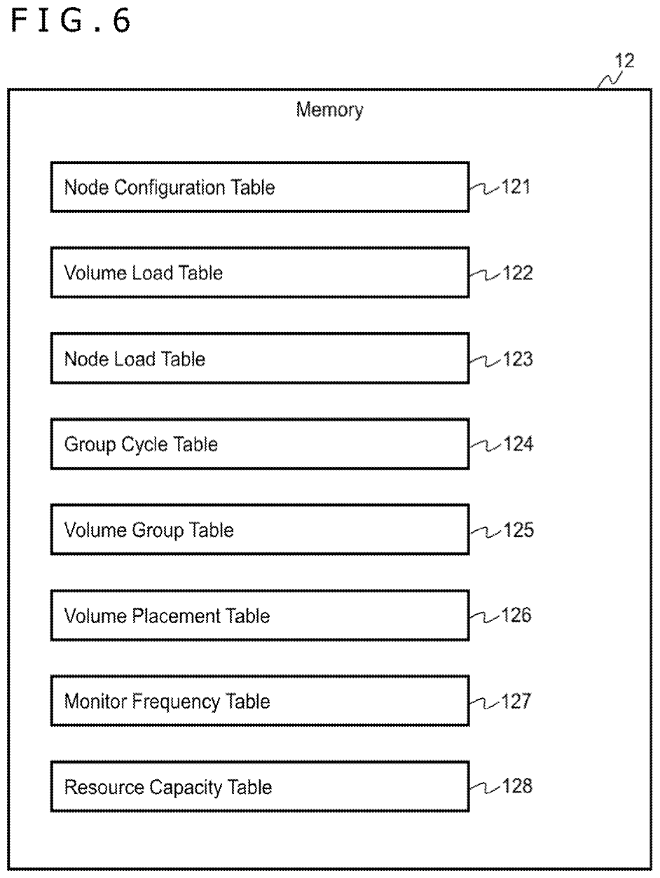

FIG. 6 is a block diagram showing an example of a configuration of a memory map. As shown in FIG. 6, the memory 12 of the storage node 10 stores various kinds of tables used in processing by the distributed storage system 1 according to the present embodiment.

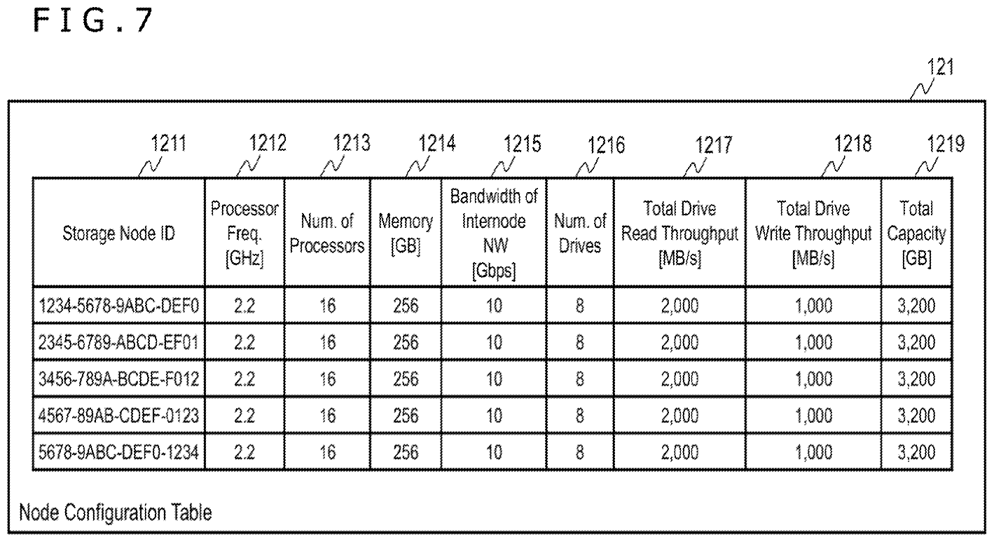

Specifically, the memory 12 stores a node configuration table 121, a volume load table 122, a node load table 123, a group cycle table 124, a volume group table 125, a volume placement table 126, a monitor frequency table 127, and a resource capacity table 128. A detailed description of each of the tables will be described later with reference to FIGS. 7 to 14.

A table configuration of each table shown in FIG. 6 will be described in detail in the following. Incidentally, in a concrete example of each illustrated table, there are parts in which the values of fields are omitted and that are left blank.

FIG. 7 is a diagram showing an example of a configuration of the node configuration table 121. The node configuration table 121 retains specifications related to hardware resources included in each node (storage node 10). Specifically, the node configuration table 121 has fields of a storage node ID 1211, a processor frequency 1212, the number of processors 1213, a memory 1214, an inter-node network bandwidth 1215, the number of drives 1216, a total drive read throughput 1217, a total drive write throughput 1218, and a total capacity 1219. Incidentally, the total capacity 1219 describes a total value of drive capacity included in a target node (storage node 10).

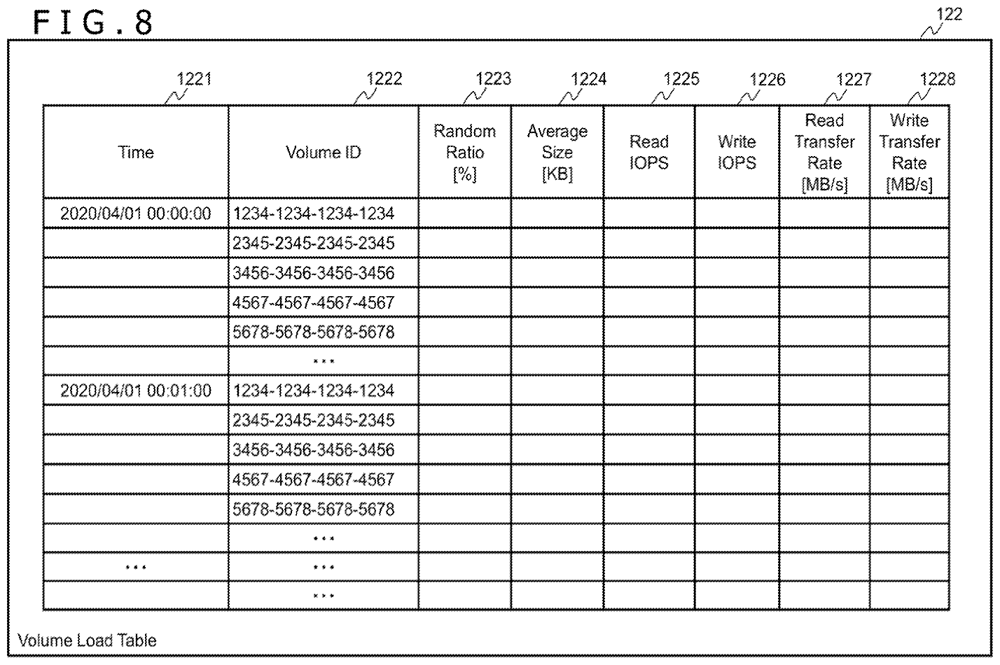

FIG. 8 is a diagram showing an example of a configuration of the volume load table 122. The volume load table 122 retains TO workload characteristics in each volume at predetermined time intervals (hereinafter referred to as each time). Specifically, the volume load table 122 has fields of a time 1221, a volume ID 1222, a random ratio 1223, an average size 1224, read IOPS 1225, write IOPS 1226, a read transfer rate 1227, and a write transfer rate 1228. Load information is recorded in the volume load table 122 in time series by periodical load information obtainment processing performed by the monitor 200.

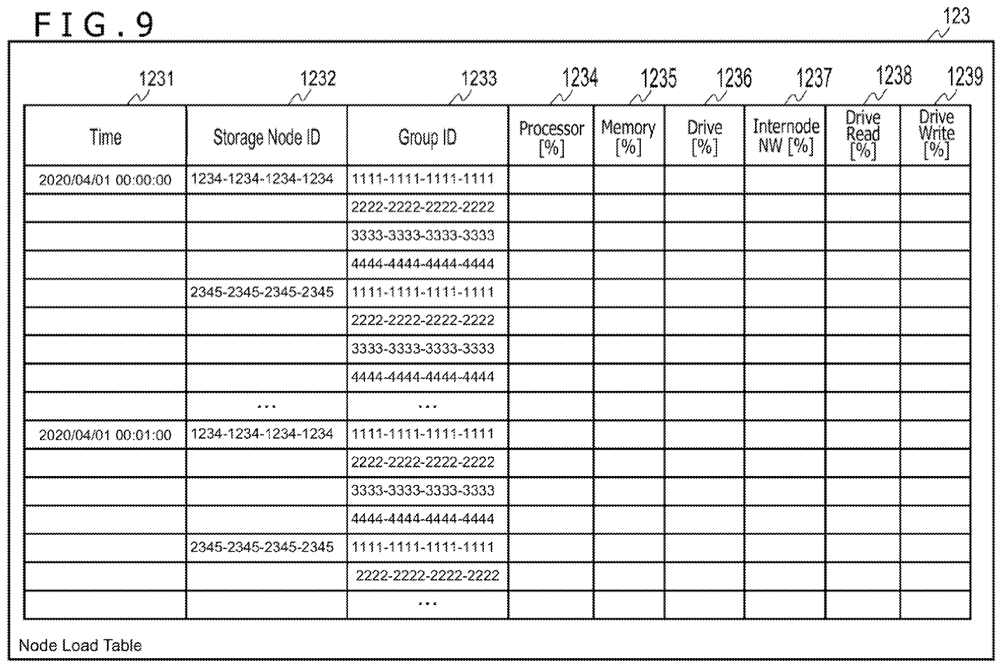

FIG. 9 is a diagram showing an example of a configuration of the node load table 123. The node load table 123 retains a load of each resource on each node at each time. Specifically, the node load table 123 has fields of a time 1231, a storage node ID 1232, and a group ID 1233 and fields indicating a load of each resource (a processor 1234, a memory 1235, a drive 1236, an inter-node network 1237, a drive read 1238, and a drive write 1239).

The value of each field in the node load table 123 can, for example, be calculated as follows. Degrees of loads on resources of each node can be calculated from the IOPS, transfer rate, random ratio, read/write ratio of each volume stored on each node from the volume load table 122. A maximum load that can be tolerated by each resource included in each node can be calculated from the node configuration table 121. Thus, a rate of each resource load can be calculated by dividing the load of each resource described above by the maximum resource load.

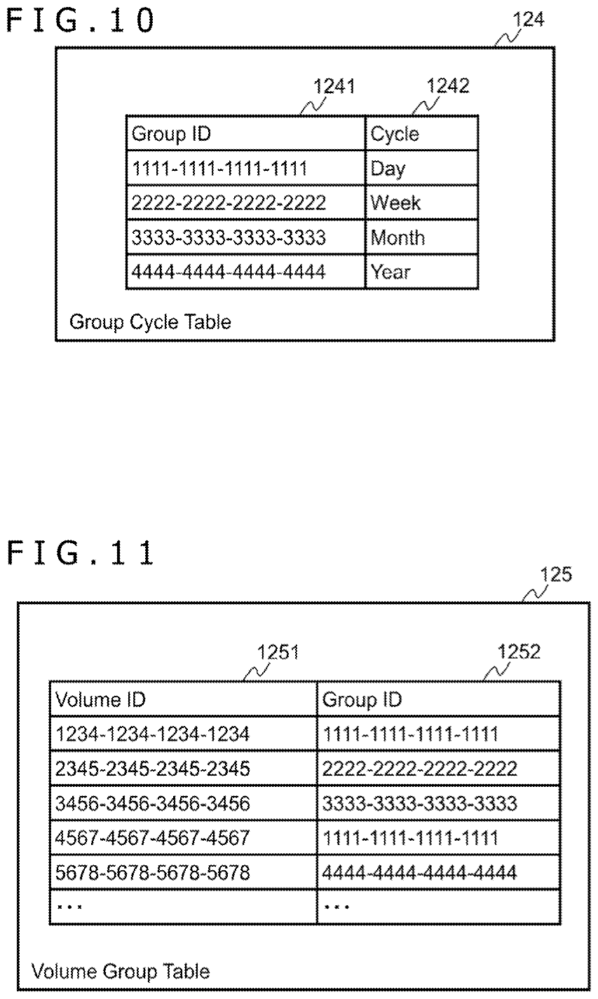

FIG. 10 is a diagram showing an example of a configuration of the group cycle table 124. The group cycle table 124 manages correspondence relations between groups and cycles. Specifically, the group cycle table 124 has fields of a group ID 1241 and a cycle 1242. As described above, in the present embodiment, volumes are classified into groups according to load fluctuation cycles. The cycle 1242 is not limited to those illustrated in FIG. 10, but optional periods such as two days or the like can be specified. In addition, the number of groups can also be set optionally. Incidentally, in the present embodiment, as described with reference to FIG. 4 and FIG. 5, resources are classified by the same classification (groups) as that of the volumes. Hence, the group ID 1241 shown in the group cycle table 124 is applied to both a resource group ID (for example, the group ID 1233 in the node load table 123 in FIG. 9) and a volume group TD (for example, a volume ID 1251 in the volume group table 125 in FIG. 11).

FIG. 11 is a diagram showing an example of a configuration of the volume group table 125. The volume group table 125 manages correspondence relations between volumes and groups. Specifically, the volume group table 125 has fields of a volume ID 1251 and a group ID 1252.

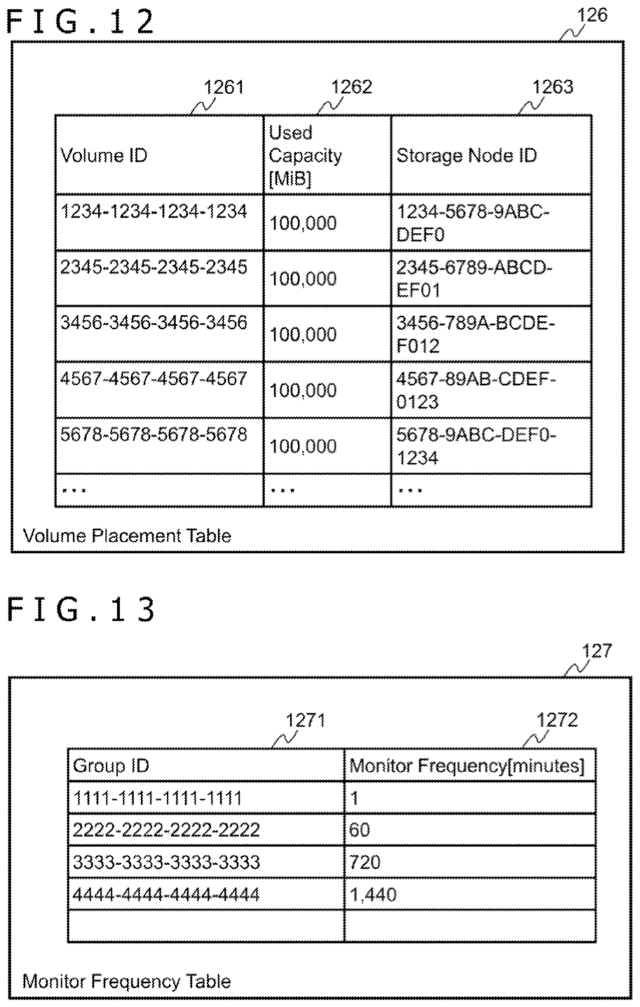

FIG. 12 is a diagram showing an example of a configuration of the volume placement table 126. The volume placement table 126 manages correspondence relations between volumes and placement destination nodes. Specifically, the volume placement table 126 has fields of a volume ID 1261, a used capacity 1262, and a storage node ID 1263. Incidentally, the used capacity 1262 describes a total value of drive capacity assigned to a volume corresponding to the volume ID 1261.

FIG. 13 is a diagram showing an example of a configuration of the monitor frequency table 127. The monitor frequency table 127 manages a frequency of obtainment of load information by the monitor 200 (monitor frequency) for each group. Specifically, the monitor frequency table 127 has fields of a group ID 1271 and a monitor frequency 1272. There are various volume load fluctuations such as frequent fluctuation in a short period, gentle fluctuation in a long period, and the like. In order to reduce an amount of calculation at a time of optimizing rearrangement of volumes by the rebalancer 500, the monitor frequency 1272 indicating a frequency at which the monitor 200 performs load information obtainment processing is set for each group (group ID 1271) in the monitor frequency table 127. As for a method of determining the monitor frequency 1272, necessary and sufficient load information can be stored by, for example, analyzing components constituting a waveform of volume load fluctuation by spectrum analysis or the like, and setting half a frequency of a component having a shortest cycle among a few components having predominant cycles. Incidentally, while the monitor frequency 1272 is adjusted with a group (group ID 1271) as a unit in the monitor frequency table 127 FIG. 13, the monitor frequency 1272 may be adjusted with a volume (volume ID) as a unit, for example.

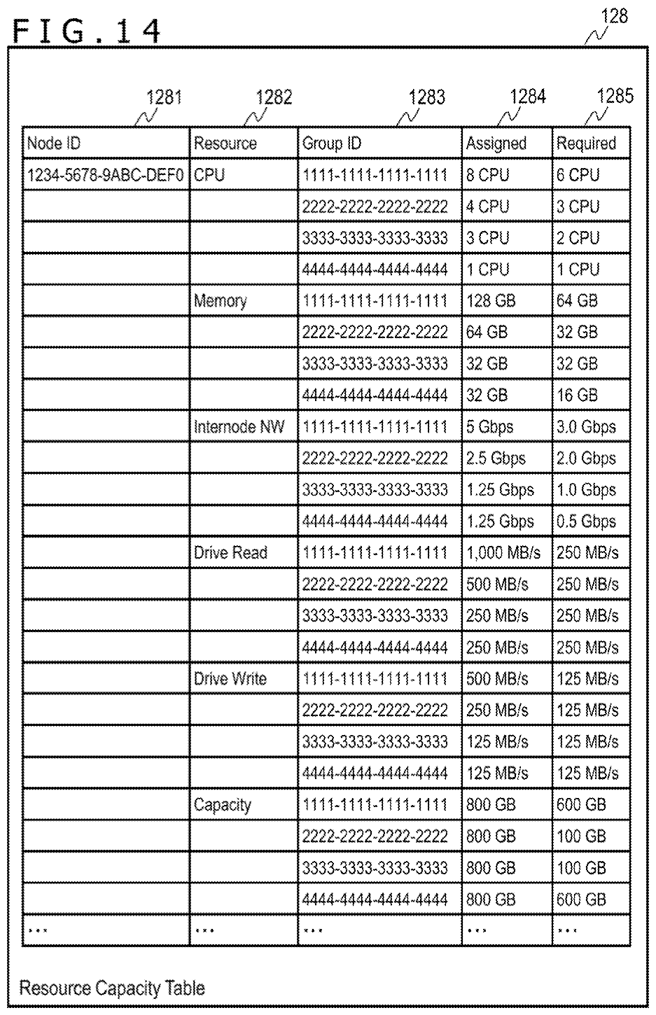

FIG. 14 is a diagram showing an example of a configuration of the resource capacity table 128. The resource capacity table 128 manages, for each of a plurality of resources possessed by each node, excess or insufficiency of resources assigned in group units. Specifically, the resource capacity table 128 has fields of a node ID 1281, a resource 1282, a group ID 1283, an assigned amount 1284, and a required amount 1285. Of the fields, the assigned amount 1284 indicates a resource amount currently assigned to each group. A total of assigned amounts 1284 for all groups in one node coincides with a hardware configuration of the node, that is, the value of the total capacity 1219 corresponding to the node in the node configuration table 121 of FIG. 7. Meanwhile, the required amount 1285 indicates a resource amount necessary to process workloads on volumes included in each group. The required amount 1285 is updated by the processing of the resource classifier 400. The rebalancer 500 adjusts an amount of assigned resources between groups on the basis of a difference between the required amount 1285 and the assigned amount 1284.

FIG. 15 is a flowchart showing an example of a processing procedure of processing by the monitor 200. The monitor 200 is called from the management controller 100 according to the load information obtainment frequency (monitor frequency 1272) for each group, the load information obtainment frequency being shown in the monitor frequency table 127 of FIG. 13, and performs processing of obtaining load information by the processing procedure shown in FIG. 15.

Specifically, first, the monitor 200 accesses the distributed storage system 1, and obtains the load information of each volume and the node providing each volume (step S11).

Next, the monitor 200 stores the load information obtained in step S11 in the volume load table 122 shown in FIG. 8 and the node load table 123 shown in FIG. 9 (step S12). More specifically, the monitor 200 stores the obtained volume load information in the fields of the random ratio 1223 to the write transfer rate 1228 in the volume load table 122, and stores the obtained node load information in the fields of the processor 1234 to the drive write 1239 in the node load table 123.

By performing the processing of steps S11 to S12 as described above, the monitor 200 can obtain the load information of the volume and the node at the frequency determined in the monitor frequency table 127, and record the load information.

Incidentally, the processing of steps S11 to S12 by the monitor 200 described above may be specifically performed by any of the following procedures. For example, the monitor 200 in step S11 may set only a group (group ID 1271) corresponding to the monitor frequency 1272 in the monitor frequency table 127 as a target and obtain only the load information of volumes and nodes belonging to the group from the distributed storage system 1, and the monitor 200 in step S12 may store the obtained load information in the volume load table 122 and the node load table 123. In addition, for example, the monitor 200, in step S11, may obtain the load information of all of volumes and nodes included in the distributed storage system 1 from the distributed storage system 1, and the monitor 200, in step S12, may store, in the volume load table 122 and the node load table 123, only the load information of the volumes and nodes belonging to the group in the load information obtained in step S11.

FIG. 16 is a flowchart showing an example of a processing procedure of processing by the volume classifier 300.

According to FIG. 16, the volume classifier 300 first starts loop processing for all groups (step S21). Specifically, the volume classifier 300 refers to the volume group table 125 of FIG. 11, and selects one unprocessed group from among all of the groups whose IDs are shown as group IDs 1252.

Next, the volume classifier 300 starts loop processing for all volumes included in the group selected in step S21 (step S22). Specifically, the volume classifier 300 refers to the volume group table 125, searches for all volumes (volume IDs 1251) in correspondence relation to the group (group ID 1252) selected in step S21, and selects one unprocessed volume from among all of the corresponding volumes.

Next, the volume classifier 300 refers to the volume load table 122, and obtains load information at all of times in the one volume selected in step S22 (step S23).

Next, the volume classifier 300 analyzes load fluctuation constituted of the load information at all of the times which load information is obtained in step S23, and identifies a longest cycle of the load fluctuation (step S24). Incidentally, a method of extracting a predominant cycle in a waveform of the load fluctuation, for example, is considered as a concrete method for analyzing the load fluctuation in step S24. In this case, the longest cycle can be identified immediately by subjecting the waveform of the load fluctuation to spectrum analysis or the like and decomposing the waveform.

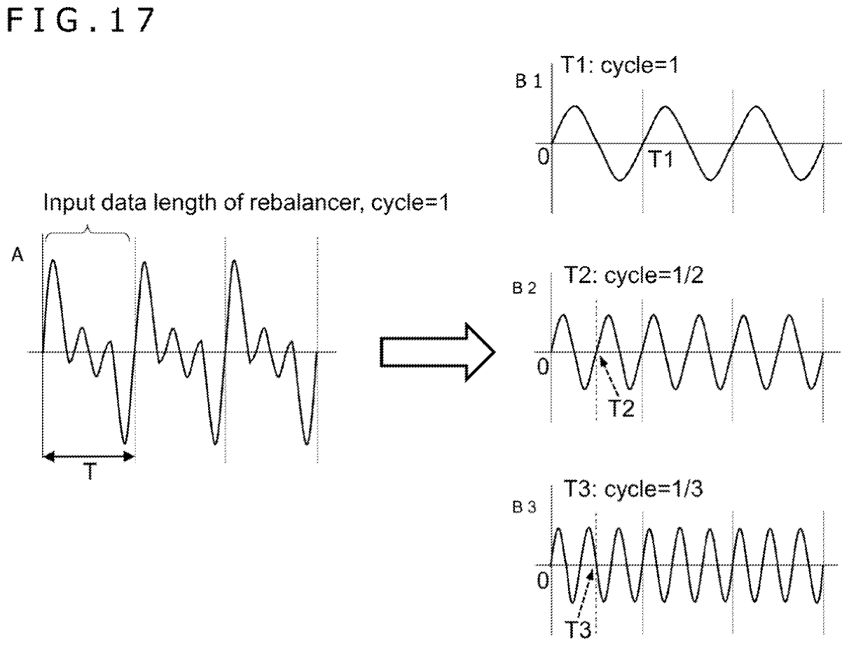

Here, FIG. 17 is a diagram of assistance in explaining the decomposition of the waveform of the load fluctuation. A left side of FIG. 17 shows a waveform A as an example of the waveform of the load fluctuation. This waveform A is a waveform having periodicity, and can be decomposed into a few sine waves. In addition, a right side of FIG. 17 shows three kinds of sinusoidal waveforms B1 to B3 decomposed by subjecting the waveform A to spectrum analysis.

A load of a volume fluctuates along a workload cycle. In a case where a few workloads are mixed in a certain volume, the waveform of the load fluctuation in the volume is represented by a periodic waveform obtained by combining the load fluctuations of the respective workloads. Hence, the waveform of the load fluctuation of the volume having periodicity can be decomposed into a few sine waves representing the load fluctuations of the respective workloads, and an amount of information necessary and sufficient to grasp the load fluctuation of the volume can be retained by identifying a longest cycle from the cycles of the respective sine waves.

Specifically, in a case where the processing of step S24 is performed on the waveform A of FIG. 17, the cycles of the respective waveforms B1 to B3 obtained by spectrum analysis of the waveform A are identified first. In this case, the cycle T1 of the waveform B1 is “1,” the cycle T2 of the waveform 132 is “½,” and the cycle T3 of the waveform B3 is “⅓.” In other words, the cycle T1 is twice the cycle T2, and is three times the cycle T3. That is, the longest cycle of the decomposed waveforms B1 to B3 is the cycle T1 of “1,” and the longest cycle T in the waveform A before the decomposition can be identified as “1.”

Then, in the group grouped by the longest cycle as described above, data necessary and sufficient for the rebalancer 500 to adjust the assignment of each resource in consideration of the load fluctuation of the volume is ensured by making information input to the rebalancer 500 be an amount of data having the same length as the longest cycle T in which the workload fluctuates (not inputting data longer than the longest cycle). Incidentally, in order for an amount of data input to the rebalancer 500 not to be an amount of data exceeding the longest cycle in which the workload fluctuates (the longest cycle of the load fluctuation), the obtainment of the load information by the monitor 200 may be limited such that the monitor 200 obtains the load information from data in the longest cycle. In the case where an amount of data in obtaining the load information is thus limited on the monitor 200 side, the information in the volume load table 122 (see FIG. 8) and the node load table 123 (see FIG. 9) is also represented on the basis of the above-described limited data amount. Thus, as a result, data necessary and sufficient to adjust the assignment of each resource in consideration of the load fluctuation of the volume is input to the rebalancer 500 as an amount of data not exceeding the above-described longest cycle.

The description returns to FIG. 16. After the processing of step S24, the volume classifier 300 approximates the longest cycle identified in step S24 to one of the cycles 1242 retained in the group cycle table 124 of FIG. 10 (that is, either one day, one week, one month, or one year), and classifies the volume selected in step S22 by the group TD 1242 corresponding to the approximated cycle 1242 (step S25). Specifically, for example, when the longest cycle of load fluctuation in a certain volume is identified as “1.5 days” in step S24, a cycle 1242 of “one day (Day)” is selected as a cycle closest to “1.5 days” in step S25. As a result, the volume is classified into the group A having a group ID 1241 of “1111-1111-1111-1111.”

Next, the volume classifier 300 updates the volume group table 125 of FIG. 11 according to the classification of the volume which classification is determined in step S25 (step S26).

Thereafter, the volume classifier 300 repeatedly performs the processing of steps S23 to S26 for all of the volumes included in the group selected in step S21, as described in step S22, and further repeatedly performs the processing of these steps S22 to S26 for all of the groups, as described in step S21. When the volume classifier 300 then ends the loop processing of step S21, the volume classifier 300 ends the whole processing of FIG. 16.

By performing the processing of steps S21 to S26 as described above, the volume classifier 300 can classify a plurality of volumes of the distributed storage system 1 into a plurality of groups according to the performance characteristics (longest cycles of load fluctuation) of the respective volumes. Then, the cycle 1242 of each volume which cycle is identified in step S25 becomes the length (period) of input data to the rebalancer 500 to be described later. Incidentally, as described earlier with reference to FIG. 4, the “longest cycle of load fluctuation” as a classification criterion for a volume corresponds to the “longest cycle in which a workload fluctuates,” the workload being included in the volume.

FIG. 18 is a flowchart showing an example of a processing procedure of processing by the resource classifier 400.

According to FIG. 18, the resource classifier 400 first starts loop processing for all nodes (step S31). Specifically, the resource classifier 400 refers to the resource capacity table 128 of FIG. 14, and selects one unprocessed node from among all of the nodes whose IDs are shown as node IDs 1281.

Next, the resource classifier 400 starts loop processing for all groups in the node selected in step S31 (step S32). Specifically, the resource classifier 400 refers to the resource capacity table 128, searches for all groups (group IDs 1283) belonging to the node (node ID 1281) selected in step S31, and selects one unprocessed group from among all of the corresponding groups.

Next, the resource classifier 400 starts loop processing for all times for the group selected in step S32 (step S33). Specifically, the resource classifier 400 refers to the node load table 123 of FIG. 9, and selects one unprocessed time from among all of the times recorded as times 1231.

Next, the resource classifier 400 refers to the node load table 123 of FIG. 9, and sums loads of all volumes included in the group selected in step S32 at the time selected in step S33 (step S34). Incidentally, the processing of step S34 is performed for all of the resources on a resource-by-resource basis.

Next, as described in step S33, the resource classifier 400 repeatedly performs the processing of step S34 for all of the times. By this loop processing, the resource classifier 400 can calculate the total load of all of the volumes included in the group selected in step S32 for each time and each resource.

Next, the resource classifier 400 obtains a time of a highest total load among the total loads of all of the volumes within the group at the respective times, the total loads being calculated by the processing of steps S33 to S34 (step S35). As with the processing of step S34, the processing of step S35 is also performed for all of the resources on a resource-by-resource basis. Incidentally, a selecting method for the time obtained in step S35 is not limited to the time of the highest total load, but may, for example, be the obtainment of a time of a highest average value of total loads or the like. A group load is defined as a load that the group can generate on the basis of the value of a maximum value of the total loads or the like.

Next, the resource classifier 400 calculates a required amount of each resource in the group, and updates the resource capacity table 128 (step S36). In step S36, the required amount of each resource can, for example, be calculated by multiplying a maximum load of the node which maximum load is determined from a hardware resource amount of each node shown in the node configuration table 121 of FIG. 7 by a ratio of the maximum load (sum of the loads which sum is obtained in step S34) at the time obtained in step S35. Then, the resource classifier 400 updates the required amount 1285 of the resource capacity table 128 of FIG. 14 with the calculated required amount of the resource.

Thereafter, the resource classifier 400 repeatedly performs the processing of steps S33 to S36 for all of the groups included in the node selected in step S31, as described in step S32, and further repeatedly performs the processing of these steps S32 to S36 for all of the nodes, as described in step S31. When the resource classifier 400 then ends the loop processing of step S31, the resource classifier 400 ends the whole processing of FIG. 18.

By performing the processing of steps S31 to S36 as described above, the resource classifier 400 can dynamically determine an assigned amount of each resource assigned to each volume in each group of volumes according to the group classification of volumes by the volume classifier 300.

FIG. 19 is a flowchart showing an example of a processing procedure of processing by the rebalancer 500.

According to FIG. 19, first, the rebalancer 500 refers to the resource capacity table 128 of FIG. 14, and determines whether or not there is a resource having a required amount 1285 exceeding an already assigned resource amount (assigned amount 1284) within a certain node (step S41).

When an affirmative result is obtained in step S41 (YES in step S41), it means that a resource imbalance has occurred between groups within the node. In this case, the rebalancer 500 proceeds to step S42, where the rebalancer 500 adjusts resource allocation between groups in the node by calling and performing group adjustment processing.

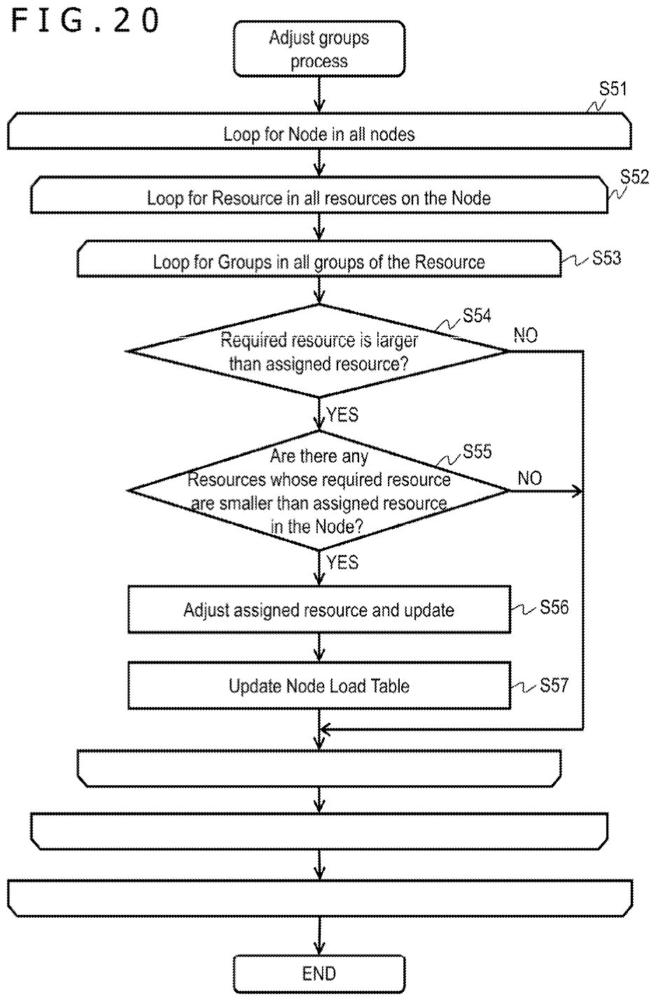

In the following, the group adjustment processing performed by the rebalancer 500 in step S42 will be described in detail with reference to FIG. 20. FIG. 20 is a flowchart showing an example of a processing procedure of the group adjustment processing.

According to FIG. 20, first, the rebalancer 500 starts loop processing for all of the nodes (step S51). Specifically, the rebalancer 500 refers to the resource capacity table 128 of FIG. 14, and selects one unprocessed node from among all of the nodes whose IDs are shown as node IDs 1281.

Next, the rebalancer 500 starts loop processing for all resources possessed by the node selected in step S51 (step 552). Specifically, the rebalancer 500 refers to the resource capacity table 128, and selects one unprocessed resource from among resources shown as resources 1282 in a record including the node (node ID 1281) selected in step S51.

Next, for the resource selected in step S52, the rebalancer 500 starts loop processing for all groups to which the resource belongs (step S53). Specifically, the rebalancer 500 refers to the resource capacity table 128, and selects one unprocessed group from among all of the groups shown as group IDs 1283 in a record including the resource 1282 selected in step S52.

Next, the rebalancer 500 refers to the resource capacity table 128, and determines whether or not the value of a required amount 1285 exceeds an assigned amount 1284 in a record of the group (first group) having the group ID 1283 selected in step S53 (step S54). When an affirmative result is obtained in step S54 (YES in step S54), it means that the resource amount assigned to the first group is insufficient with respect to the resource amount necessary to process a workload. In this case, the processing of step S55 is performed. When a negative result is obtained in step S54 (NO in step S54), on the other hand, the processing of steps S55 to S57 is skipped, and a return is made to the loop processing of step S53.

In step S55, the rebalancer 500 determines whether or not there is a group (second group) in which a required amount 1285 is smaller than an assigned amount 1284, the group being different from the first group, for the resource selected in step S52 on the node selected in step S51. When an affirmative result is obtained in step S55 (YES in step S55), it means that there is a surplus in the resource amount assigned to the second group with respect to the resource amount necessary to process a workload. In this case, the processing of step S56 is performed. When a negative result is obtained in step S55 (NO in step S55), on the other hand, the processing of steps S56 to S57 is skipped, and a return is made to the loop processing of step S53.

In step S56, the rebalancer 500 changes resource assignments so as to accommodate a resource from the second group to the first group within the same node, and updates the assigned amounts 1284 in the resource capacity table 128 of FIG. 14 with the assigned amounts after the change. More specifically, it suffices for the rebalancer 500 to change resource assignments so as to, for example, assign a part of a surplus amount resulting from subtraction of the required amount 1285 of the second group from the assigned amount 1284 of the second group to the assigned amount 1284 of the first group. In addition, at this time, when only the surplus amount of the one second group cannot cancel out the insufficient resource amount of the first group, resource assignments may be changed so as to assign surplus amounts of a plurality of second groups to the assigned amount of the first group. By thus performing the processing of step S56, it is possible to mutually accommodate resources between groups within the same node.

Next, the rebalancer 500 updates the node load table 123 of FIG. 9 on the basis of the resource capacity table 128 updated in step S56 (step S57). Specifically, for example, a ratio between the assigned amount 1284 after the update of the resource and the assigned amount 1284 before the update is applied to the load at each time, and thereby the load of the resource can be calculated.

Thereafter, the rebalancer 500 repeatedly performs the processing of steps S54 to S57 for all of the groups to which the resource selected in step S52 belongs, as described in step S53, further repeatedly performs the processing of steps S53 to S57 for all of the resources possessed by the node selected in step S51, as described in step S52, and further repeatedly performs the processing of these steps S52 to S57 for all of the nodes, as described in step S51. When the rebalancer 500 then ends the loop processing of step S51, the rebalancer 500 ends the whole processing of FIG. 20.

By performing the processing of steps S51 to S57 as described above, the rebalancer 500 can adjust, for each group of volumes, resource assignment between groups within the same node.

The description returns to FIG. 19. After an affirmative result is obtained in step S41 and the group adjustment processing of step S42 is performed, or when a negative result is obtained in step S41 (NO in step S41), the rebalancer 500 performs the processing of step S43.

In step S43, the rebalancer 500 refers to the node load table 123 of FIG. 9, and determines whether or not there is a time period in which a load of each resource exceeds a predetermined upper limit value.

When an affirmative result is obtained in step S43 (YES in step S43), it means that a resource imbalance has occurred between nodes. In this case, the rebalancer 500 proceeds to step S44, where the rebalancer 500 performs volume migration (transfer) between nodes and thus adjusts resource assignment by calling and performing volume rearrangement processing.

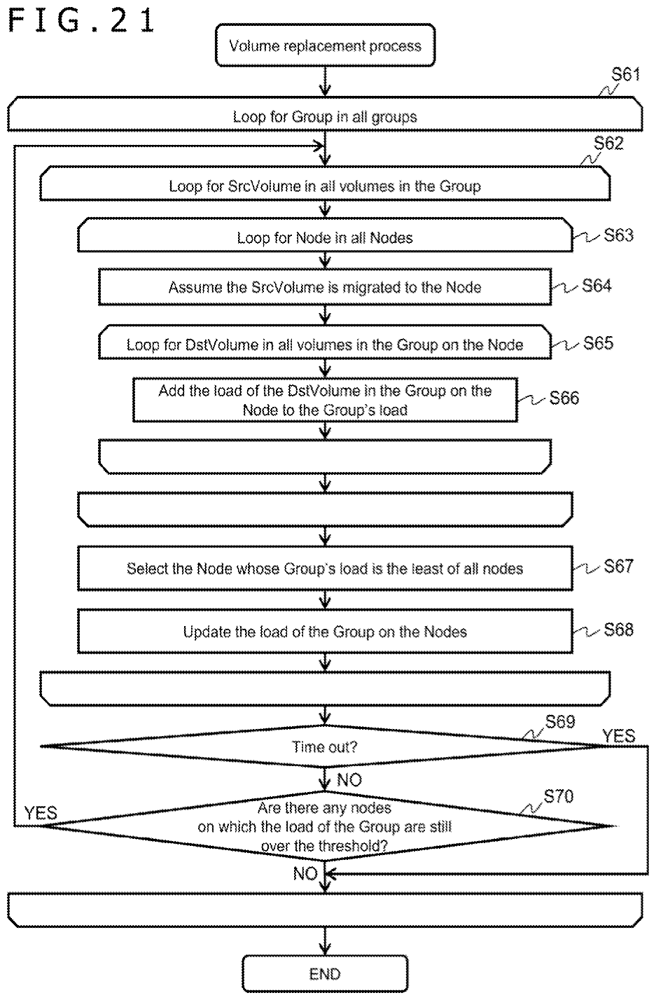

Here, the volume rearrangement processing performed by the rebalancer 500 in step S44 will be described in detail with reference to FIG. 21. FIG. 21 is a flowchart showing an example of a processing procedure of the volume rearrangement processing.

According to FIG. 21, first, the rebalancer 500 starts loop processing on all groups (step S61). Specifically, the rebalancer 500 refers to the volume group table 125 of FIG. 11, and selects one unprocessed group on which the processing of steps S62 to S67 is not performed from among all of the groups whose IDs are shown as group IDs 1252. The group selected here will hereinafter be referred to as a “group in question.”

Next, the rebalancer 500 starts loop processing on all transfer source volumes belonging to the group in question (step S62). The transfer source volumes are, for example, selected in decreasing order of a degree to which a load threshold value is exceeded. When selection is thus made, volumes exceeding the load threshold value to a high degree can be selected preferentially even when transfer destination nodes for all of the volumes are not found. In step S62, specifically, the rebalancer 500 refers to the volume load table 122 of FIG. 8, searches for volumes (transfer source volumes) in which the load information of each resource (the random ratio 1223 to the write transfer rate 1228) exceeds a predetermined threshold value among all volumes corresponding to the group in question that is selected in step S61 (see FIG. 11), and selects one unprocessed transfer source volume on which the processing of steps S63 to S67 is not performed yet from among the searched-for transfer source volumes.

Next, the rebalancer 500 starts loop processing on all of movement destination nodes (step S63). The above “movement destination nodes” are a term defining nodes as movement destination candidates for the transfer source volume. All of nodes having resources excluding the node to which the transfer source volume selected in step S62 belongs correspond to the movement destination nodes. In step S63, specifically, the rebalancer 500 refers to the resource capacity table 128 of FIG. 14, and selects one unprocessed transfer destination node on which the processing of steps S64 to S66 is not performed from among the transfer destination nodes excluding the node to which the transfer source volume selected in step S62 belongs from all of the nodes whose IDs are shown as node IDs 1281.

Next, the rebalancer 500 assumes that the transfer source volume selected in step S62 is migrated to the transfer destination node selected in step S63 (step S64).

Next, under the assumption of the migration in step S64, the rebalancer 500 starts loop processing on all of volumes belonging to the group in question on the transfer destination node with each volume set as a transfer destination volume (step S65).

In the loop processing of this step S65, the rebalancer 500 calculates a predicted value of a group load of all of the volumes belonging to the group in question on the transfer destination node (which predicted value will hereinafter be referred to as a “predicted group load on the transfer destination node”) in conditions in which the migration is assumed in step S64. Specifically, the rebalancer 500 sets the predicted group load on the transfer destination node at “0” at a time of a start of the loop processing of step S65, and adds a load of the transfer destination volume to the predicted group load on the transfer destination node in step S66. Then, in the loop processing of step S65, the rebalancer 500 repeatedly performs the processing of step S66 for each volume (transfer destination volume) belonging to the group in question on the transfer destination node. Thus, by the loop processing of step S65, the rebalancer 500 can calculate, as the “predicted group load on the transfer destination node,” a value obtained by summing the loads of all of the volumes (including the transfer candidate volume) belonging to the group in question on the transfer destination node.

Further, when the processing of steps S64 to S66 described above is repeatedly performed and the loop processing of step S63 is ended, the predicted group load on the transfer destination node in the case where the transfer source volume is migrated to the transfer destination node is calculated for all of the transfer destination node candidates.

Then, on the basis of the result of the loop processing of step S63, the rebalancer 500 compares the predicted group loads on the transfer destination nodes as the respective transfer destination node candidates with each other, and selects a candidate node having a smallest predicted group load as the transfer destination node to which to actually migrate the transfer source volume (step S67). As described earlier, the predicted group load on the transfer destination node is a total value of the loads of the respective volumes belonging to the group in question on the transfer destination node. This total value tends to be smaller in a case where peaks of the loads in the respective volumes are distributed (shifted) than in a case where the peaks coincide with each other. That is, in step S67, the rebalancer 500 attaches importance to the shift between the peaks of the loads in the respective volumes, and selects, as the transfer destination node, a node in which a small increase occurs in the group load at the movement destination when the transfer source volume is moved.

Next, according to the transfer destination node for the transfer source volume, the transfer destination node being selected (determined) in S67, the rebalancer 500 updates the group loads in the group in question on the node to which the transfer source volume belongs and the transfer destination node (step S68). It is thereby possible to determine transfer destination nodes for subsequent volumes while considering the load of the transfer source volume for which the transfer destination node is determined previously.

Then, when the processing of steps S63 to S68 described above is repeatedly performed, and the loop processing of step S62 is ended, the transfer destination node for migration of each volume (transfer source volume) whose load exceeds a predetermined threshold value among the volumes belonging to the group in question is selected, and a state is obtained in which the group load of the group in question is equal to or less than the threshold value.

When the loop processing of step S62 is ended, the rebalancer 500 determines whether or not an elapsed time of the volume rearrangement processing for the group in question selected in step S61 exceeds a time limit set for each group (step S69). When the elapsed time is within the time limit (NO in step S69), the processing proceeds to step S70. When the elapsed time exceeds the time limit (NO in step S69), step S70 is skipped.

In step S70, the rebalancer 500 determines whether there is a node on which the group load in the group in question exceeds the threshold value (step S70). When there is a node on which the group load exceeds the threshold value (YES in step S70), the processing returns to step S62. When there is no node on which the group load exceeds the threshold value (NO in step S70), the loop processing of S61 is continued.

Then, by repeatedly performing the processing of steps S62 to S70 described above as the loop processing of step S61, the rebalancer 500 can determine volumes (transfer source volumes) for which to perform migration and nodes (transfer destination nodes) as movement destinations of the volumes for all of the groups. Then, according to this determination, the rebalancer 500 performs migration of the transfer source volumes to the transfer destination nodes in optional timing.

By performing the processing of steps S61 to S70 as described above, the rebalancer 500 can adjust resource assignments by performing migration of volumes between nodes within each group.

The description returns to FIG. 19. After an affirmative result is obtained in step S43 and the volume rearrangement processing of step S44 is performed, or when a negative result is obtained in step S43 (NO in step S43), the rebalancer 500 ends the processing.

As a result of performing the processing of steps S41 to S44 as described above, the rebalancer 500 according to the present embodiment adjusts a resource imbalance between groups within a node by the group adjustment processing (step S42) in a case where the imbalance has occurred between the already assigned resource amount (assigned amount 1284) and the resource amount necessary to process a workload (required amount 1285), and adjusts a resource imbalance by performing migration of volumes between nodes within a same group by the volume rearrangement processing (step S44) in a case where the imbalance has occurred in load of each resource between nodes. As a result, the rebalancer 500 can adjust the assignment of each resource to each volume classified in each group. Incidentally, when the group adjustment processing is performed before the volume rearrangement processing as in the processing procedure shown in FIG. 19, and a resource imbalance is resolved by only performing the group adjustment processing, an effect of being able to shorten a processing time on a system (for example a hypervisor) side can be expected because migration does not have to be performed between nodes.

As described above, in the distributed storage system 1 according to the present embodiment, the monitor 200 obtains load information in each of a plurality of volumes at a predetermined obtainment frequency, and the volume classifier 300 classifies the plurality of volumes into a plurality of groups on the basis of a load fluctuation cycle (more specifically, the longest cycle in which a workload fluctuates) in each volume. It is thereby possible to reduce the number of volumes and the number of pieces of load information at each time as targets of rebalancing calculation by the rebalancer 500. In addition, the resource classifier 400 classifies resources possessed by a plurality of nodes into the plurality of groups according to the classification of the plurality of volumes into the plurality of groups. It is thereby possible to dynamically determine an assigned amount of each resource assigned to each volume. The distributed storage system 1 according to the present embodiment has the configuration of the monitor 200, the volume classifier 300, and the resource classifier 400, and can thereby reduce a calculation amount of combinatorial optimization calculation between volumes when the rebalancer 500 performs rebalancing processing that adjusts assignment of each resource to each volume in each group.

Effects of reducing an amount of rebalancing calculation (combinatorial optimization calculation between volumes) in the present embodiment will be described in detail in the following.

Conventionally, in a distributed storage system in which various workloads are mixed, an optimization algorithm that searches for an optimum volume placement on each node is used in order to appropriately place volumes on each node so as to satisfy data requirements. In this typical optimization algorithm, an optimum volume placement can be searched for by solving a combinatorial optimization problem between volumes. However, letting n be the number of volumes, an amount of calculation of the combinatorial optimization problem increases by O(n²). This is because in a case where each transfer source volume is transferred to another node by rebalancing processing, loads at each time are calculated including loads of volumes on the transfer destination node and a volume placement proposal is searched for, and thus the amount of calculation is increased according to the number of volume combinations. Therefore, in the conventional distributed storage system in a large-scale environment with a large number n of volumes, the amount of calculation of the combinatorial optimization problem between the volumes is very large, so that it is difficult to take timely action because a period of calculation is lengthened, and a large amount of resources for calculation are needed to solve the optimization problem.

For the above-described problems, the distributed storage system 1 according to the present embodiment can reduce the number of volumes per group by classifying the plurality of volumes provided by the distributed storage system 1 into a plurality of groups. Then, as rebalancing processing, the rebalancer 500 adjusts assignment of each resource to each volume by performing combinatorial optimization calculation between volumes in each group. Thus, when the plurality of volumes are divided into n groups, for example, the calculation amount of the combinatorial optimization calculation between the volumes can be reduced to “1/n,” as expressed in the following Equation 1.

[Equation 1]

n[group]×(1/n[volume])²=1/n (1)

That is, the distributed storage system 1 according to the present embodiment can reduce the calculation amount of the combinatorial optimization calculation between the volumes by reducing the number of calculation target volumes in the rebalancing processing by the rebalancer 500, and thus perform the rebalancing processing in a shorter period than the conventional distributed storage system.

In addition, in the present embodiment, in a case where the monitor 200 obtains load information with the data length of the cycle of load fluctuation (the longest cycle in which a workload fluctuates) which cycle is used in grouping the volumes when the monitor 200 periodically obtains the load information of the volumes, necessary and sufficient information for rebalancing calculation processing by the rebalancer 500 can be obtained with an optimum data length. Then, setting this data length as the data length of input data to the rebalancer 500 enables the rebalancer 500 to perform the rebalancing processing more efficiently. In addition, an effect of reducing calculation resources for storing the load information can also be expected.

In addition, in the present embodiment, when a load on each volume is assumed to fluctuate according to a time series, the load has an identical or approximate load fluctuation cycle (cycle in which a workload fluctuates), and by placing volumes having different load peaks on a same node, it is possible to place many volumes on each storage node efficiently without the load of the volumes interfering with each other. Therefore, efficient grouping can be performed by grouping the volumes according to the load fluctuation cycles of the volumes.

As described above, the distributed storage system 1 according to the present embodiment can reduce the calculation amount of combinatorial optimization calculation between volumes, and achieve timely management of the storage system and a reduction in calculation resources. Incidentally, the distributed storage system 1 according to the present embodiment is more suitable for a use case where there are a large number of nodes as in a private cloud, various workloads are mixed with each other, and prediction and optimization of loads by human hand are difficult.

It is to be noted that the present invention is not limited to the foregoing embodiments, but includes various modifications. For example, the foregoing embodiments are described in detail to describe the present invention in an easily understandable manner, and are not necessarily limited to embodiments including all of the described configurations. In addition, a part of a configuration of a certain embodiment can be replaced with a configuration of another embodiment, and a configuration of another embodiment can be added to a configuration of a certain embodiment. In addition, for a part of a configuration of each embodiment, another configuration can be added, deleted, or substituted.

In addition, a part or the whole of configurations, functions, processing units, processing means, and the like described above may be implemented by hardware by making design thereof by an integrated circuit, for example. In addition, configurations, functions, and the like described above may be implemented by software by interpreting and executing a program implementing each function by a processor. Information of the program implementing each function, a table, a file, and the like can be placed in a memory, a recording device such as a hard disk or a solid state drive (SSD), or a recording medium such as an integrated circuit card (IC card), a secure digital card (SD card), or a digital versatile disc (DVD).

In addition, in the drawings, control lines and information lines considered to be necessary for description are illustrated, and not all of control lines and information lines in a product are necessarily illustrated. Almost all of configurations may be considered to be interconnected in practice.

What is claimed is:

1. A distributed storage system comprising:
a plurality of nodes connected to each other by a network, having a processor and a memory, and configured to provide a plurality of volumes from and to which a higher level system inputs and outputs data; and
a storage medium configured to store the data input and output to the volumes;
the plurality of volumes being classified into a plurality of groups on a basis of a fluctuation cycle of a load in each volume,
the processor calculating a total load obtained by summing the loads of the plurality of volumes on a same node within a group at each time, and calculating a group load on a basis of a peak of the total load, and
the processor of one node calculating the group load on a movement destination node in a case where a volume as a movement candidate in rebalancing that moves the volume between nodes is moved from a movement source node to the movement destination node, determining a volume to be moved in the rebalancing and a movement destination volume on a basis of the calculated group load on the movement destination node, and performing the rebalancing.

2. The distributed storage system according to claim 1, wherein
the processor calculates the group load on a basis of a maximum peak of peaks of the total load.

3. The distributed storage system according to claim 1, wherein
each of the nodes
assigns a resource of the node to each group on the own node on a basis of the group load, and
changes the assignment of the resource and performs the rebalancing when the group load is changed.

4. The distributed storage system according to claim 1, wherein
the load of each volume is decomposed into sine wave components, and the classification into the groups on the basis of the cycle of the load is performed on a basis of a longest cycle of cycles of the sine wave components.

5. The distributed storage system according to claim 1, wherein
the cycle used for the classification into the groups is a predetermined cycle determined in advance,
the predetermined cycle includes one day, one week, one month, and one year, and
the classification is performed on a basis of a longest fluctuation cycle as one of one day, one week, one month, and one year.

6. The distributed storage system according to claim 1, wherein
the processor of one node selects the movement destination node on a basis of an amount of increase in the group load on the movement destination node in the case where the volume as the movement candidate is moved.

7. The distributed storage system according to claim 1, wherein
the processor of one node
selects the volume as the movement candidate from a target group on the movement source node,
calculates the group load on the movement destination node in the case where the volume as the movement candidate is moved from the movement source node to the movement destination node, and determines that movement is to be performed when determining that the movement is appropriate, and
repeats selecting the volume as the movement candidate and determining that movement is to be performed until the load after the movement satisfies a predetermined condition.

8. The distributed storage system according to claim 1, wherein
selection of the volume as the movement candidate is started with a volume having a high load, and
the selection of the volume as the movement candidate is ended when the group load on the movement source node after the volume as the movement candidate is moved becomes lower than a predetermined value.

9. The distributed storage system according to claim 2, wherein
the load includes a plurality of kinds of loads, and
for the maximum peak for calculating the group load, loads at different times for each kind of load can be used.

10. The distributed storage system according to claim 2, wherein
the load includes a plurality of kinds of loads, and
the maximum peak for calculating the group load is a peak of a sum of the plurality of kinds of loads.

11. The distributed storage system according to claim 1, wherein
the load includes a load of the processor, a load of the memory, and a load of the network that connects the plurality of nodes to each other.

12. The distributed storage system according to claim 1, wherein
the storage medium is possessed by each of the plurality of nodes, and
the load further includes a load of the storage medium.

13. A rebalancing processing method performed by a distributed storage system including a plurality of nodes connected to each other by a network, having a processor and a memory, and configured to provide a plurality of volumes from and to which a higher level system inputs and outputs data, and a storage medium configured to store the data input and output to the volumes, the rebalancing processing method comprising:
classifying the plurality of volumes into a plurality of groups on a basis of a fluctuation cycle of a load in each volume;
by the processor, calculating a total load obtained by summing the loads of the plurality of volumes on a same node within a group at each time, and calculating a group load on a basis of a peak of the total load; and
by the processor of one node, calculating the group load on a movement destination node in a case where a volume as a movement candidate in rebalancing that moves the volume between nodes is moved from a movement source node to the movement destination node, determining a volume to be moved in the rebalancing and a movement destination volume on a basis of the calculated group load on the movement destination node, and performing the rebalancing.
